(19) United States
(12) Patent Application Publication
(10) Pub. No.: US 2007/0068321 A1
(43) Pub. Date: Mar. 29, 2007

(54) Adjustable pedal assembly

(75) Inventors: Se-il Song, Seoul (KR); Jungwon Park, Chonan (KR); Dongwon Lee, Chonan (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Korea Automotive Technology Institute

(21) Appl. No.: 11/508,959

(22) Filed: Aug. 24, 2006

(30) Foreign Application Priority Data
Aug. 25, 2005 (KR) 10-2005-0078087

(51) Int. Cl. G05G 1/14

(52) U.S. Cl. 74/512

(57) ABSTRACT

Disclosed is an adjustable pedal assembly. The adjustable pedal assembly includes a pedal arm hingeably mounted to a support bracket, a pedal part disposed at an end portion of the pedal arm, a gear assembly fixedly mounted to the pedal arm, and driving means for driving the gear assembly. The gear assembly includes a first gear part for receiving a driving force of the driving means, and a second gear part engaged with the first gear part for moving the gear assembly according to a driving direction of the first gear part to thereby change a position of the pedal arm.

### PRIORITY CLAIM

This application claims the benefit under 35 U.S.C. § 119(a) of a Korean patent application filed in the Korean Intellectual Property Office on Aug. 25, 2005, and assigned Korean Patent Application Serial No. 10-2005-0078087, the entire contents of which are hereby incorporated by reference.

### BACKGROUND OF THE INVENTION

1. Field of the Invention

The present invention relates to an adjustable pedal assembly, and more particularly, to such a pedal assembly which is position-adjustable in a brake pedal assembly and an accelerating pedal assembly used for driving a vehicle.

2. Background of the Related Art

In general, a pedal which is operated by a driver's stepping is mounted at an end portion of a pedal assembly of a vehicle, and it is often necessary to change a relative position between the pedal and the driver according to the driver's body conditions. In order to change the relative position therebetween, it is typical to adjust a position of a seat of the driver forwardly or rearwardly. That is, if a distance between the pedal and the driver is far, the seat is moved forwardly, but if the distance between the pedal and the driver is near, the seat is moved rearwardly, whereby the relative position between the pedal and the driver can be adjusted.

However, if a distance between a driver and a steering wheel of the vehicle is too short, a safety problem may occur to him or her at the time of a vehicle accident. Particularly, if the vehicle is equipped with an air bag, there is a serious danger of an injury since the air bag hits the driver before a great expansion pressure of the air bag is appropriately reduced.

To address and solve the above problem, an adjustable pedal assembly has been developed to appropriately adjust the relative position between the pedal and the driver only by adjusting the position of a brake pedal or an accelerating pedal without changing the position of the seat. Now, such a pedal assembly is equipped on some of the vehicles being produced.

However, the adjustable pedal assembly which is developed and commercialized now is very complex in structure, restricted in installation and operation space, and has too much components, so that it has several problems such as instability in operation, deterioration in durability and difficulty in assembly, etc.

For example, U.S. Pat. No. 6,453,767 discloses an adjustable control pedal apparatus. In U.S. Pat. No. 6,453,767, a bracket is mounted on a pedal arm, and the relative position between the bracket and the pedal arm is adjusted by an operation of a gear assembly mounted on the bracket, so that the position of the pedal can be adjusted. However, in the above structure, there has been a problem in that since the bracket is an indispensable constituent element, a volume of the entire system is increased.

### SUMMARY OF THE INVENTION

Accordingly, the present invention has been made in view of the above problems, and it is an object of the present invention to provide an adjustable pedal assembly, which is simple in structure and installation, little restricted in an installation space, improved in durability, and reduced in manufacturing costs, and ensures an exact operation.

To achieve the above object, according to the present invention, there is provided a adjustable pedal assembly including: a pedal arm hingeably mounted to a support bracket; a pedal part disposed at an end portion of the pedal arm; a gear assembly fixedly mounted to the pedal arm; and driving means for driving the gear assembly, wherein the gear assembly includes a first gear part for receiving a driving force of the driving means, and a second gear part engaged with the first gear part and moving the gear assembly according to a driving direction of the first gear part to thereby change a position of the pedal arm.

The first gear part is a worm gear, the second gear part includes a pinion engaged with the worm gear and a jack screw engaged with the pinion, and the gear assembly is moved by receiving lateral pressure from the pinion.

In case where the pedal assembly is a brake pedal assembly, it is preferable that the jack screw is connected to a push rod. However, in case where the pedal assembly is an accelerating pedal assembly, it is preferable that the jack screw is connected in such a way as to permit an operation of an accelerating cable. It is preferable that the push rod and the jack screw are connected with each other by means of a rotary joint.

In the case of the accelerating pedal assembly, the pedal assembly further comprises a linkage pivotably connected to the jack screw by means of a rotary joint, an accelerating pedal sliding part slidably moved by an operation of the linkage and connected to the accelerating cable, and a guide member for guiding the slidable movement of the accelerating pedal sliding part.

It is preferable that the guide member is provided with an arc-shaped groove formed thereon for guiding the accelerating pedal sliding part.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of a pedal assembly according to the present invention;

FIG. 2 is an exploded perspective view of a gear assembly according to the present invention;

FIG. 3 is a side sectional view showing states before and after a position adjustment when the present invention is applied to a brake pedal assembly;

FIG. 4 is a side sectional view showing states before and after a position adjustment of a brake push rod and the gear assembly of the pedal assembly illustrated in FIG. 3;

FIG. 5 is a view showing a connection structure of the push rod, a brake pedal arm and the gear assembly when the present invention is applied to the brake pedal assembly;

FIG. 6 is a side sectional view showing states before and after the position adjustment when the present invention is applied to an accelerating pedal assembly;

FIG. 7 is a side sectional view showing states before and after the position adjustment of a linkage and the gear assembly of the pedal assembly illustrated in FIG. 6;

FIG. 8 is a view showing a connection structure of an accelerating pedal guide member, an accelerating pedal sliding part, the linkage, the gear assembly, and an accelerating pedal arm;

FIG. 9 is a structural view of the accelerating pedal sliding part and the guide member; and

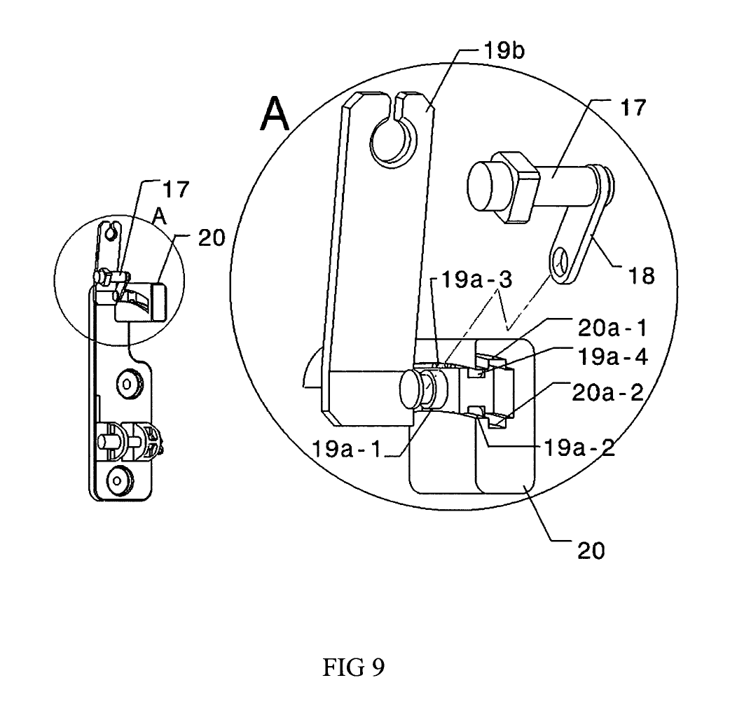

FIG. 10 is a structural view of a stopper for restricting an operation range of the accelerating pedal.

### DETAILED DESCRIPTION OF THE PREFERRED EMBODIMENT

Reference will now be made in detail to the preferred embodiments of the present invention, examples of which are illustrated in the accompanying drawings.

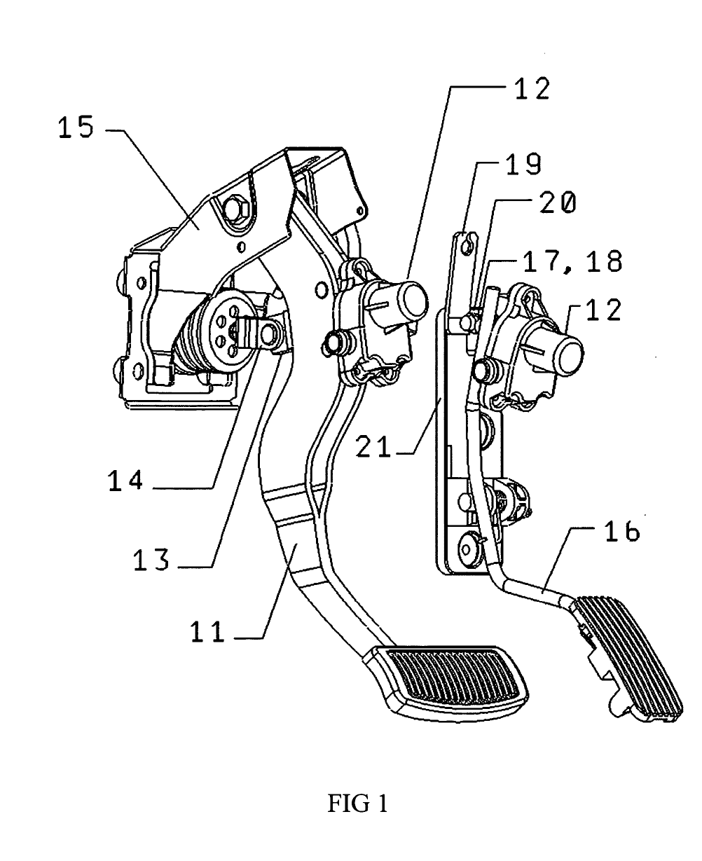

FIG. 1 is a perspective view of a pedal assembly according to the present invention. In the drawing, the left side is an example where the present invention is applied to a brake pedal assembly, and the right side is an example where the present invention is applied to an accelerating pedal assembly.

First, the brake pedal assembly will be described hereinafter. The brake pedal assembly according to the present invention is adapted to be fixed to a brake pedal bracket 15 to fixed to a frame of a vehicle, and includes a brake pedal arm 11b hingeably mounted to the brake pedal bracket 15, a pedal 11a disposed at an end portion of the brake pedal arm 11b, and a gear assembly 12 fixedly mounted to the brake pedal arm 11b.

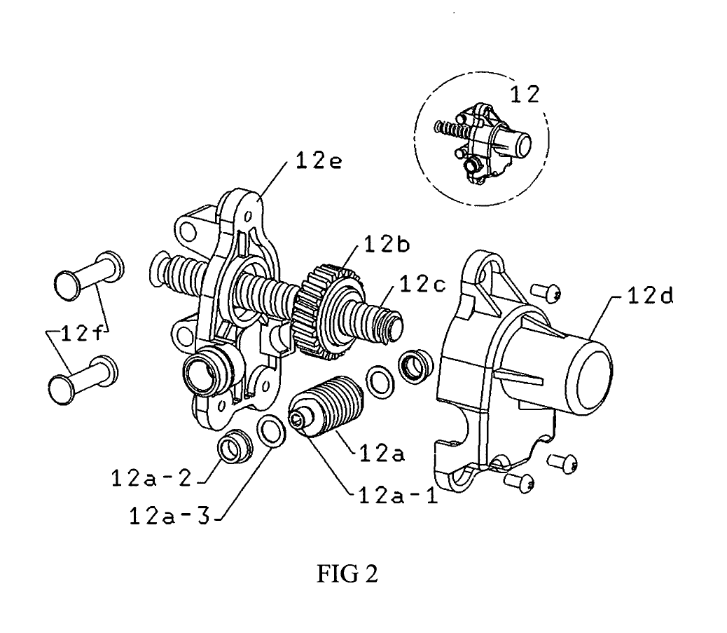

FIG. 2 is an exploded perspective view of the gear assembly 12. The gear assembly 12 includes a worm gear 12a supplied with a driving force from driving means (not shown), a pinion 12b engaged with the worm gear 12a, and a jack screw 12c engaged with the pinion 12b. The worm gear 12a, the pinion 12b and the jack screw 12c are accommodated in the gear assembly 12 by a first side wall 12d and a second side wall 12e. The jack screw 12c protrudes outwardly from the second side wall 12e. The first and second side walls 12d and 12e are coupled to each other. Such structure of the gear assembly 12 can be applied to both the brake pedal assembly and the accelerating pedal assembly in the same way.

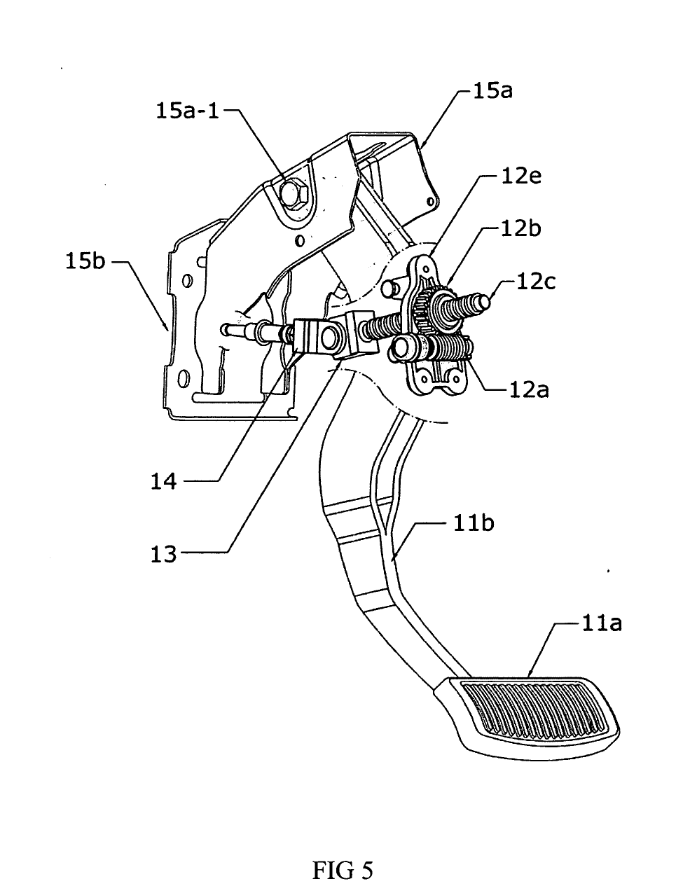

FIG. 5 shows a connected relation of the brake pedal arm 11b, the gear assembly 12 and a push rod of the brake pedal assembly. It is preferable that both end portions of a push rod 14 are connected to the gear assembly 12 by means of a rotary joint so as to have a degree of freedom in rotation. The reason is to prevent a mechanical structure phenomenon from occurring when the brake pedal assembly is adjusted in position. The gear assembly 12 is forcedly coupled to the brake pedal arm 11b or connected by means of a pin 12f.

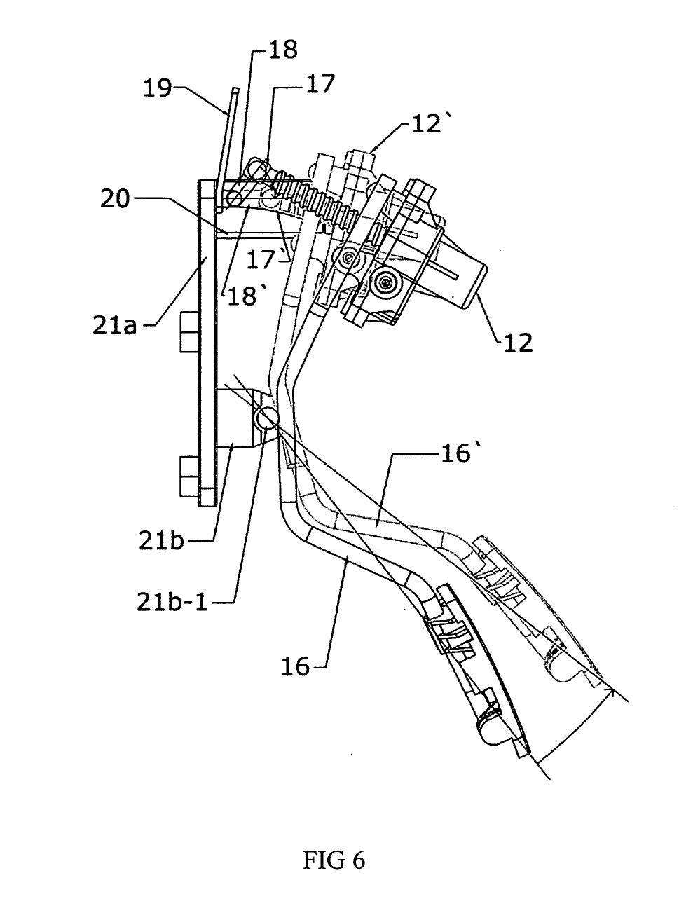

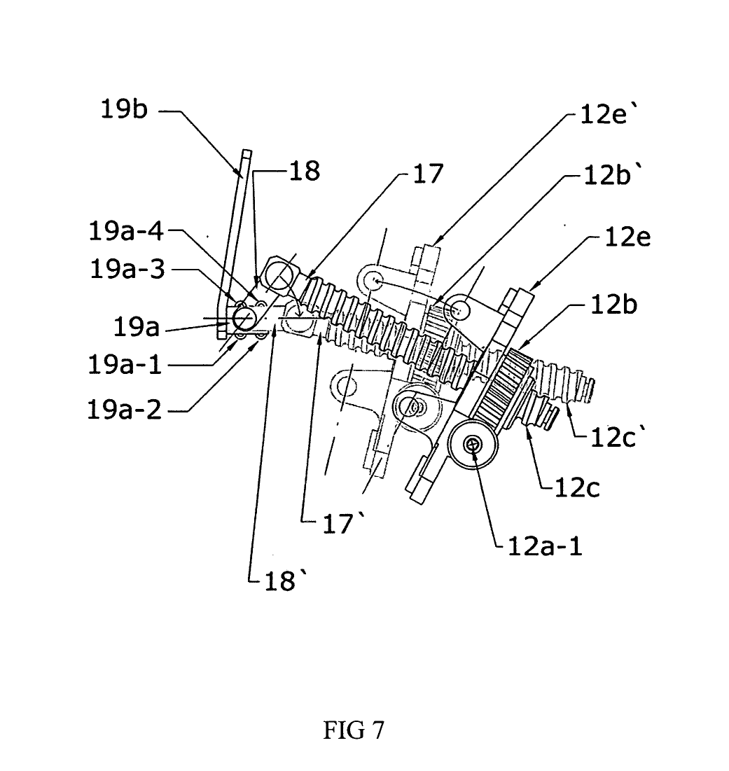

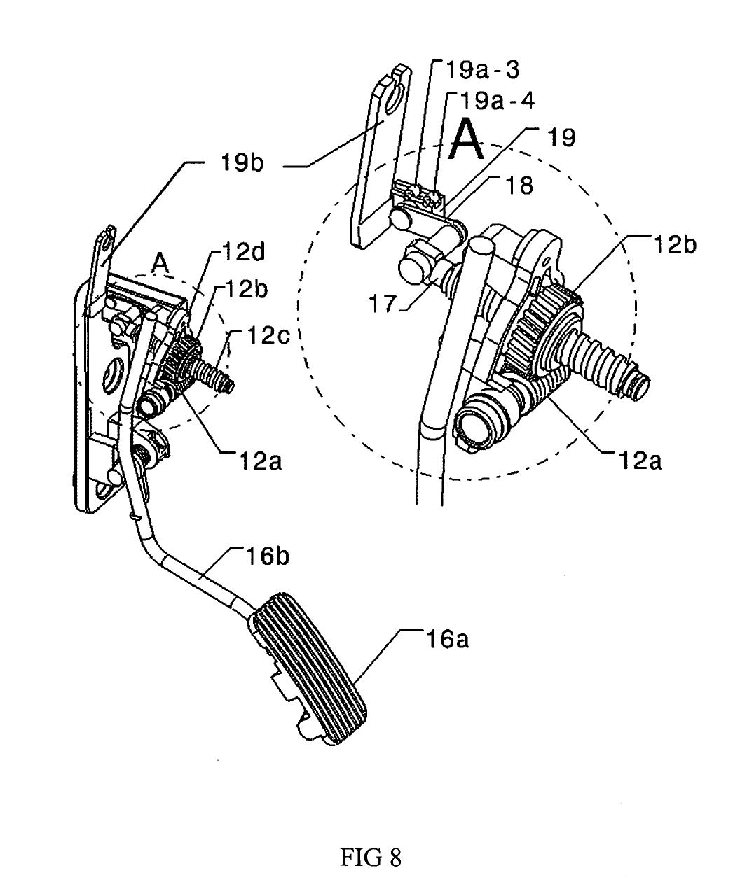

Next, a structure of the accelerating pedal assembly will be described. The structure of the accelerating pedal assembly is shown in the right side of FIG. 1, and FIGS. 6 to 8.

The accelerating pedal assembly is hingeably mounted to an accelerating pedal bracket 21 fixed on a frame of a vehicle. Differently from the brake pedal assembly which is hingeably mounted at an end thereof to the bracket, the accelerating pedal assembly is hingeably mounted to the accelerating pedal bracket 21 by means of a hinge bracket 21b-1 at an approximately central portion thereof, but not at an end portion. The hinge bracket 21b-1 is fixed to the accelerating pedal bracket 21.

Also, the gear assembly 12 is directly fixed to an accelerating pedal arm 16b, and at which time, its fixing method is the same as the brake pedal assembly. However, a linkage 18 is connected to an end portion of the jack screw 12c. The linkage 18 is also connected to an accelerating pedal sliding part 19. It is preferable that the linkage 18 is connected to the jack screw 12c and the accelerating pedal sliding part 19 by means of a rotary joint. The reason is to prevent the mechanical structure phenomenon, similarly to the case of the push rod 14.

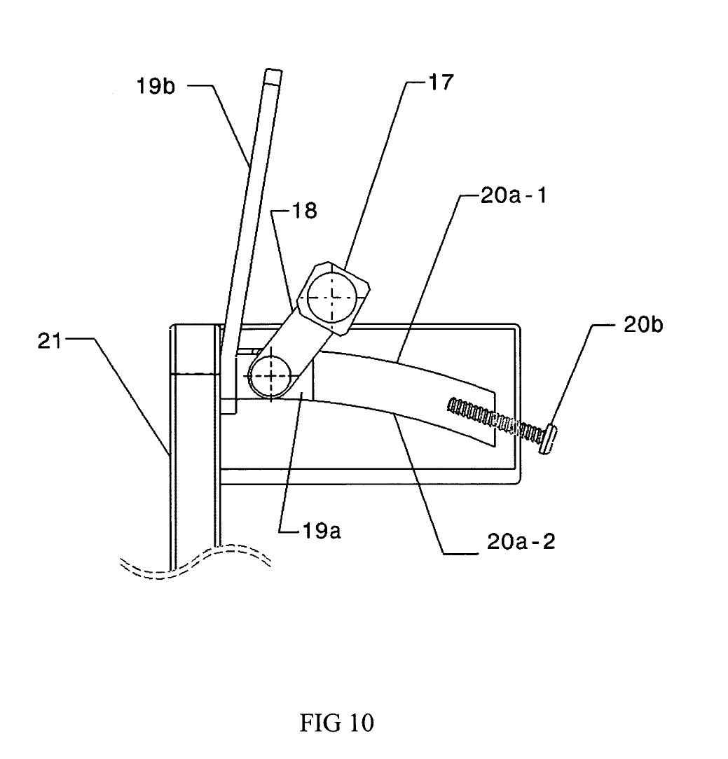

An accelerating cable (not shown) is connected to the accelerating pedal sliding part 19, and the slidable movement of the accelerating pedal sliding part 19 is controlled by a guide member 20. The guide member 20 is provided with guide grooves 20a-1 and 20a-2 formed thereon along a path where the accelerating pedal sliding part 19 is moved. Furthermore, the guide member 20 is also provided with a stopper 20b for restricting the slidable movement of the accelerating pedal sliding part 19 within a proper range. More concretely, the accelerating pedal sliding part 19 is restricted in movement by the bracket 21a when the accelerating pedal arm 16 is in a completely closed state, and the maximum movement range of the accelerating pedal arm 16b is restricted by the stopper 20b as shown in FIG. 10 when acceleration is applied by an operation of the accelerating pedal arm 16.

During the acceleration, to uniformly maintain an operation angle of the linkage 18 and minimize a vertical interference force against the guide grooves, which may be generated between the accelerating pedal guide member 20 and the accelerating pedal sliding part 19, the guide grooves 20a-1 and 20a-2 are formed in an arc shape as shown in FIG. 10. It is preferable that the arc-shaped guide grooves are formed on a pedal arm hinge 21b-1. However, as described in the claims which will be explained later, it is obvious to those skilled in the art that any arc shape is included in the scope of claims of the present invention.

Hereinafter, the operation of the pedal assembly according to the present invention will be described.

First, the operation of the pedal assembly generated at the time of the change of the relative position between the pedal assembly and a driver will be described. Since the brake pedal assembly and the accelerating pedal assembly are substantially the same in operation, only the operation of the brake pedal assembly will be described.

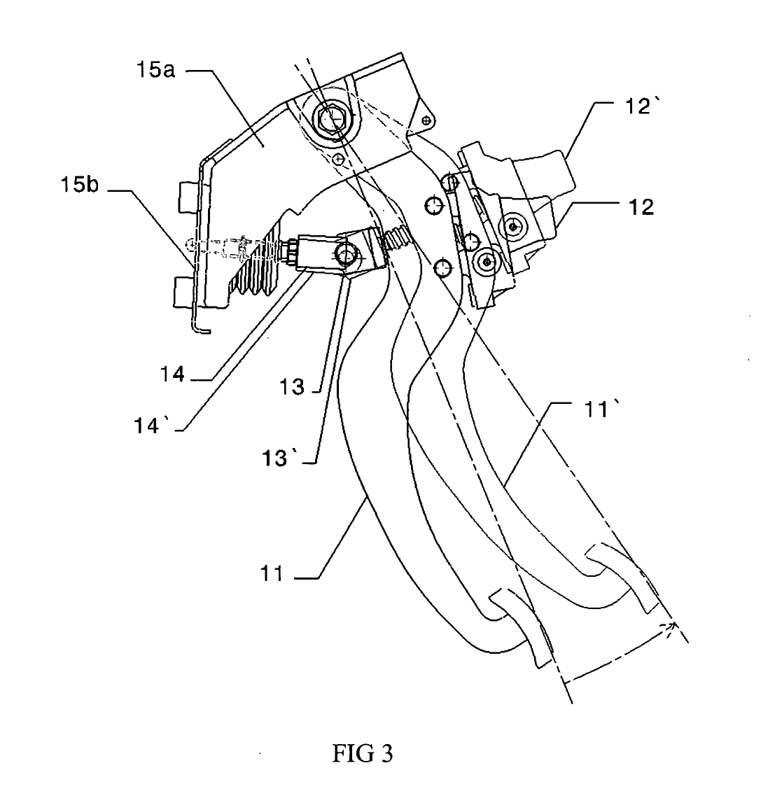

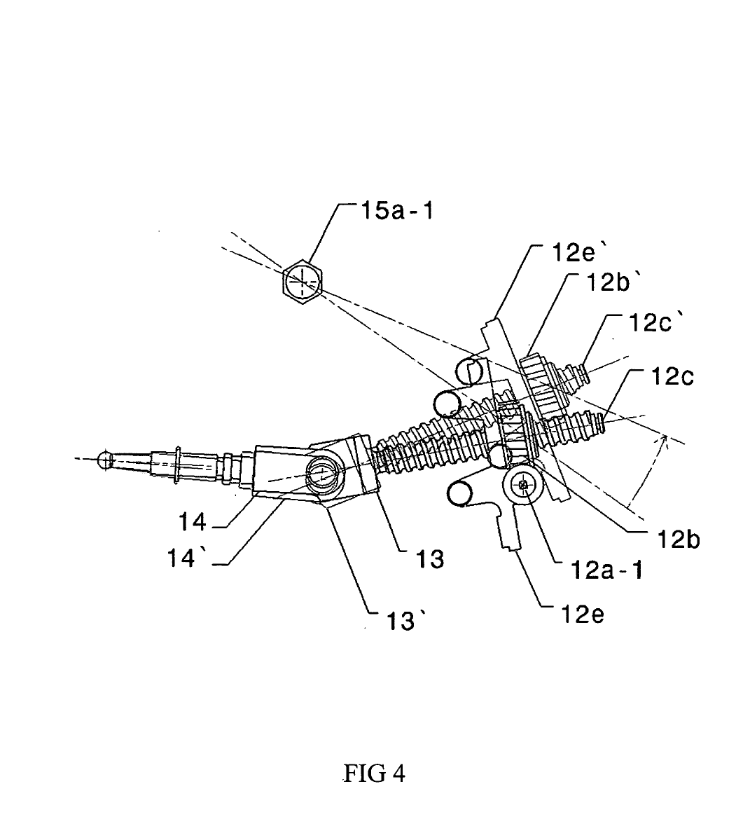

To adjust the relative position between the brake pedal assembly and the driver, the driving means connected to the worm gear 12a is operated. The driving means rotates the worm gear 12a in the clockwise direction or in the counterclockwise direction. FIG. 3 is a side sectional view of the brake pedal assembly before and after the position adjustment, and FIG. 4 is a side sectional view of the push rod 14 and the jack screw 12c before and after the position adjustment. In the drawings, the state before the position adjustment is indicated with a thick line and the state after the position adjustment is indicated with a thin line.

When the driving means is operated, the worm gear 12a is rotated, and the pinion 12b engaged with the worm gear 12a is dependently rotated. At this time, the pinion 12b performs a translational motion along an axial direction of the jack screw 12c through a mutual action with the jack screw 12c which is processed into the pinion 12b, and presses the first side wall 12d of the gear assembly 12. That is, the gear assembly 12 is moved in the rearward direction of the vehicle, and the brake pedal 11a fixed to the gear assembly 12 is moved toward the driver. When it is judged that the brake pedal 11a reaches a proper position, the driver stops the operation of the driving means, and then, a new position of the brake pedal 11a is set. If the driver wants to change the position of the brake pedal 11a in a direction in which the brake pedal 11a becomes more distant from the driver, the driver manipulates the operation direction of the driving means in the opposite direction. Then, the pinion 12b presses and moves the second side wall 12e of the gear assembly 12, and so, the position of the brake pedal 11a is changed in the direction in which the brake pedal 11a becomes more distant from the driver.

During the position adjustment of the brake pedal assembly, the pedal arm 11b is rotated about a hinge shaft 15a-1 of the bracket 15. However, since the gear assembly 12 and the pedal arm 11b are fixed as described above, they maintain a uniform angle, so that the connected point of the gear assembly 12 and the push rod 14 performs the translational motion in a vertical direction of the vehicle. At this time, if the push rod is completely restricted, the mechanical structure phenomenon occurs. To prevent the mechanical structure phenomenon, as described above, the end portions of the push rod 14 are connected to the gear assembly by means of the rotary joint to provide the push rod 14 with the degree of freedom in rotation.

In the accelerating pedal assembly, it is preferable that both end portions of the linkage are connected to the gear assembly by means of the rotary joint in order to prevent the mechanical structure phenomenon.

Hereinafter, a braking operation and an acceleration operation vehicleried out after the position adjustment of the pedal assembly 11 or 16 will be described. First, the braking operation will be described.

For the braking operation, the driver applies power to the brake pedal 11a, and then, the brake pedal arm 11b is rotated in the clockwise direction about the hinge shaft 15b-1 of the bracket 15. By the rotation, the gear assembly 12 fixed on the brake pedal arm 11b is moved in the frontward direction of the vehicle, namely, in a braking direction. Therefore, the push rod 14 connected with the gear assembly is moved in the front direction of the vehicle.

The power transmitted through the push rod 14 is changed according to an operation angle of the push rod 14 little by little, and particularly, a vertical power of the vehicle is generated at a connected portion between a booster, which is a braking force distribution device installed in front of the push rod 14, and the push rod 14. The driver may feel a discontinuous pedal reaction force at the time point when directions of the vertical power cross each other. To solve the above problem, it is preferable that the operation angle between the push rod 14 and the ground horizontal line is kept in such a way as to have a positive value or a negative value in all areas at the time of braking.

Now, the acceleration will be described. When the driver applies power to the accelerating pedal 16a, the accelerating pedal arm 16b is rotated in the clockwise direction about the hinge shaft 21b-1 of the accelerating pedal bracket 21. By the rotation, as shown in FIG. 6, the gear assembly 12 fixed on the accelerating pedal arm 16b is moved to the rear of the vehicle, namely in an acceleration direction.

Then, the linkage 18 connected to the jack screw 12c is moved toward the rear of the vehicle, and the accelerating pedal sliding part 19 hingeably coupled with the linkage 18 is moved slidably along the accelerating pedal guide members 20a-1 and 20a-2. By the slidable movement of the accelerating pedal sliding part 19, an accelerating cable connected to the accelerating pedal sliding part 19 is pulled, so that the vehicle is accelerated.

As described above, the adjustable pedal assembly according to the present invention is very simple in structure and installation position of the gear assembly for movement of the pedal arm, ensures reliability in operation due to the appropriate arrangement of the linkages and the push rod, and reduces manufacturing costs since the number of the components is relatively reduced. Moreover, the adjustable pedal assembly according to the present invention can greatly increase durability by lowering an occurrence rate of troubles of the components, and be easily applied to a restricted installation space.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An adjustable pedal assembly comprising:
a pedal arm hingeably mounted to a support bracket;
a pedal part disposed at an end portion of the pedal arm;
a gear assembly fixedly mounted to the pedal arm; and
driving means for driving the gear assembly,
wherein the gear assembly includes a first gear part for receiving driving force of the driving means, and a second gear part engaged with the first gear part, said second gear part moving the gear assembly in a driving direction of the first gear part, thereby changing a position of the pedal arm.

2. The adjustable pedal assembly according to claim 1, wherein the first gear part is a worm gear, the second gear part includes a pinion engaged with the worm gear and a jack screw engaged with the pinion, and the gear assembly is moved by lateral pressure from the pinion.

3. The adjustable pedal assembly according to claim 2, wherein the jack screw is connected to a push rod, and the pedal assembly is a brake pedal assembly.

4. The adjustable pedal assembly according to claim 2, wherein the jack screw is connected in such a way as to permit an operation of an accelerating cable, and the pedal assembly is an accelerating pedal assembly.

5. The adjustable pedal assembly according to claim 4, further comprising:
a linkage pivotally connected to the jack screw by means of a rotary joint;
an accelerating pedal sliding part slidably moved by an operation of the linkage and connected to the accelerating cable; and
a guide member for guiding the slidable movement of the accelerating pedal sliding part.

6. The adjustable pedal assembly according to claim 5, wherein the guide member is provided with an arc-shaped groove formed thereon for guiding the accelerating pedal sliding part therealong.

7. The adjustable pedal assembly according to claim 3, wherein the jack screw and the push rod are connected with each other by means of a rotary joint.
